(19) United States
(12) Patent Application Publication
(10) Pub. No.: US 2010/0059596 A1
(43) Pub. Date: Mar. 11, 2010

(54) MANUFACTURE OF LABELS WITH RFID TRANSPONDERS

(76) Inventor: Karl-Heinz Achhammer, Worth/Donau (DE)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/065,242

(22) PCT Filed: Jun. 30, 2006
(86) PCT No.: PCT/EP2006/006405

§ 371 Date: Jun. 2, 2008

(30) Foreign Application Priority Data
Aug. 31, 2005 (DE) 102005041221.1

(51) Int. Cl. G06K 19/06; B23P 19/00; H01P 11/00

(52) U.S. Cl. 235/492; 29/729; 29/600

(57) ABSTRACT

A device for manufacturing a label for a container, particularly for a bottle, which comprises a RFID production device, which is designed to form at least a part of a Radio Frequency Identification (RFID) transponder during the manufacture of the label. Also, procedure for manufacturing a label for a container, particularly for a bottle, where at least apart of the RFID transponder is formed during the manufacture of the label.

### CROSS-REFERENCE TO RELATED APPLICATIONS

The present application claims the benefit of priority of International Patent Application No. PCT/EP2006/006405, filed on Jun. 30, 2006, which application claims priority of Gelman Patent Application No. 10 2005 041 221.1, filed Aug. 31, 2005. The entire text of the priority application is incorporated herein by reference in its entirety.

### FIELD OF THE DISCLOSURE

The present disclosure relates to a device for manufacturing labels for containers, particularly for bottles, and to a label manufacturing procedure, and relates particularly to a device and a procedure for manufacturing labels that present RFID transponders.

### BACKGROUND

The use of automatic identification procedures for goods and products is widespread. A particularly cost effective procedure is based on barcodes, which, printed in the form of adhesive plates or on labels, for example, allow the automatic reading of data that identify and specify the goods.

However, barcodes present the problem that they can represent only a very limited amount of data, and it is impossible to write again on them, that is they are not “reprogrammable.” Consequently, barcodes and barcode readers have been replaced increasingly in recent times by RFID (Radio Frequency Identification) systems.

RFID systems include a reading device and a RFID transponder (a RFID tag). The reading device comprises typically a high frequency transmitter and receiver, and a coupling element, a coil or antenna, for communication with a transponder. In addition, the reading device, in many applications, supplies energy to the transponder by emitting a high-frequency electromagnetic field, which induces a voltage in the antenna coil of the transponder.

The RFID transponder also comprises a coupling element and an electronic microchip, which contains the data in question in a memory. The transponder is normally coupled inductively or by backscattering with the laser device. In the first case the laser device reads data from the transponder by load modulation of the electromagnetic field emitted by the reading device, which modulation is produced by an appropriate load resistance, which is controlled by the data of the transponder.

Because of the unprogrammability, the high data storage capacity, and the visible readability of a RFID transponders, they can be used advantageously in connection with labels on containers, such as, bottles. Thus, the German Utility Model DE 200 10 351 discloses a bottle label which presents a RFID transponder, and which can be embedded particularly in or between two layers of the label paper.

However, before the bottle label is printed on, it must be provided with the RFID transponder. Consequently, the labeling process itself must be preceded by the assembly of the label paper and the RFID transponder, which makes the entire labeling process more complicated and slower.

Therefore, it is desirable to make available a device and a procedure which allow a more efficient and reliable manufacture of labels for containers, for example, bottles, where the labels present RFID transponders, and thus also simplify the labeling.

A device for manufacturing a label for a container, particularly for a bottle, is made available by the present disclosure, which comprises a RFID production device, which is configured so that it forms at least a part of a Radio Frequency Identification (RFID) transponder during the manufacture of the label.

The term “label” should be understood here in a very broad sense. On the one hand, it denotes a printed support medium, such as, paper or a special film (PET), each optionally with an adhesive lacquer coating, an upper electrical insulation layer or a similar part, on which a RFID transponder is formed at least in part according to the disclosure. On the other hand, the term “label” can also relate to printing directly on a container, such as, a bottle. In this case, an image, writing, etc., and at least a part of the RFID transponder are printed without support medium on the surface of the container.

The RFID production device can thus be designed in such a way that at least a part of the RFID transponder is formed on a support medium or directly on a surface of the container. The support medium can also be located on the container, or it can be appropriate for application on the surface of the container.

The RFID transponder may be such that it operates, for example, in a low frequency range (below 135 kHz), in a middle frequency range (6.7-27.3 MHz) or in an ultrahigh frequency range (433 MHz-5.9 GHz).

Because at least a part of a RFID transponder is formed during the label manufacture, manufacture a label that comprises at least one RFID transponder is simpler and more efficient in its design than the state of the art.

The RFID production device can comprise a printing device for printing a part of a RFID transponder, where the printing device may be designed advantageously so that it prints an electrically conductive ink. In this way conductors, coils and antennas can be printed with electrically conductive ink.

The Willi ink is understood here very generally and not limited to ink based on water, oil, etc., which contains electrically conducting particles, such as, high-grade steel chips, copper particles, or similar materials, rather it comprises any electrically conducting fluid which is appropriate for printing, for example, with the help of conventional printing heads. The ten!' ink here also includes particularly polymers, which can be printed with high precision in very thin layers one on top of the other, and which can be processed similarly to ink.

Only relatively slight and obvious modifications of existing printing devices of installations for manufacturing labels and of labeling machines are required to form parts of a RFID transponder during the manufacturing of labels by printing with the help of electrically conductive ink.

The RFID production device can be designed advantageously in such a way that particularly an antenna is formed as a part of the RFID transponder. The antenna represents the coupling element of the RFID transponder, and it can be constructed particularly simply during the label manufacture, particularly by printing with electrically conductive ink.

According to a variant of the device according to the , the RFID production device can be configured in such a way that it forms at least a part of a RFID microchip as a part of the RFID transponder. Forming a part of a RFID transponder, for example, with the help of electrically conductive ink, is thus not limited particularly to the production of an antenna.

Analog and digital switching circuits, as well as conductors and components of integrated circuits can be formed and particularly printed.

Furthermore, the device according to the disclosure can comprise an embossing device and/or an ink or color control device and/or a drying device and/or a hardening device and/or an insulation device and/or a device for arranging a RFID microchip and/or a printing device for printing with color inks.

The embossing device can be configured so that it embosses a support medium or a container surface before being printed on. Ink that is printed into the embossings can be fixed better. An antenna can be formed and optionally insulated preferably in the embossings by printing with electrically conductive ink. A control device can control, for example, by optical control, the formation of the embossing edges.

The drying device can be a near infrared drying device and serve to dry the printed ink. The hardening device can be an ultraviolet hardening device and be used for hardening ink, but also for hardening a connection of a microchip to the remaining label, where the connection can be made with the device for arranging a RFID microchip. The latter device can be used to apply a microchip to the label, to bring it in electrical contact with the antenna of the RFID transponder, and to connect it, for example, by gluing, with the support medium or the surface of the container.

The insulation device ensures the electrical insulation of at least parts of the RFID transponder. In particular, it can be used to apply an insulation layer over the antenna. The mentioned printing device for printing color ink can be used for the additional printing on an area of the label in which no electrically conductive ink is needed.

The present disclosure also provides a labeling machine, which comprises a device for manufacturing a label as described above, and a carousel for conveying the containers, which are introduced into the carousel at an inlet, and which leave the carousel through an outlet.

The above-mentioned problem is also solved by the procedure according to the disclosure for manufacturing a label for a container, particularly for a bottle, which is characterized in that at least a part of the RFID transponder is formed during the manufacture of the label.

Labeling of a container can also occur after the production of the label, or the label can be formed directly on the surface of the container, or on a support medium which is applied to the surface of the container.

According to the disclosure, at least a part of the RFID transponder can be formed by printing, and the printing can comprise printing with an electrically conductive ink. An antenna can be designed as a portion of the RFID transponder. Before the printing, an electrostatic preliminary treatment of the surface to be printed on can take place, for example, by ionizing an air layer above the surface, for example, with the help of a corona discharge device.

The at least one part of the RFID transponder can be formed on a support medium, or alternatively directly on a surface of the container. The support medium can be applied to a surface of the container, or it may be appropriate for being applied to the surface.

Furthermore, at least a part of a RFID microchip can be formed as a part of the RFID transponder. Thus, for example, conductors of the chip and/or components of the latter can be printed.

According to a variant, the procedure for manufacturing a label by printing-embossing can comprise the embossing of a support medium or of a surface of the container, to form an embossed area, where the printing of at least a part of the RFID transponder occurs in the embossed area.

In addition, one can carry out a drying, particularly near infrared drying, and/or a hardening, particularly ultraviolet hardening, of the electrically conductive ink, if such an ink is used.

The method can also comprise the formation of an insulation layer over at least a part of the RFID transponder or over at least a part of the antenna.

In addition, a RFID microchip can be arranged in such a way that it is in electrical contact with the antenna. If the antenna has been insulated completely beforehand, then the insulation must be eliminated locally for this purpose. An already finished RFID microchip can be applied to the label, or a RFID microchip which is produced at least partially during the manufacture of the label is arranged in electrical contact with the antenna. UV hardening can follow the adhesive attachment of a RFID microchip in electrical contact with the antenna.

The present disclosure moreover makes available a label for a container, particularly for a bottle, which comprises at least a RFID transponder, and which is characterized in that it is manufactured by one of the above described procedures. The antenna of the at least one REID transponder can here be a part of the printed area of the label, which can comprise a support medium, or it can be printed directly on the container.

Below, embodiment examples of a device according to the disclosure and of a procedure according to the disclosure are described in reference to the drawing. The described embodiments are in all regards merely illustrative and they must not be considered limiting; in addition various combinations of the indicated characteristics are included in the disclosure.

### BRIEF DESCRIPTION OF THE DRAWINGS

FIG. 1 shows components of an embodiment of a labeling machine, which comprise a device for manufacturing labels according to the present disclosure, which in turn comprises a printing device which is designed to print an antenna for a RFID transponder on a support medium of a label, and a device which applies a RFID microchip to the label and connects it with the label in electrical contact with the antenna.

FIG. 2 illustrates examples of processing steps in the manufacture of a label with the help of a carrier medium, where a RFID transponder is at least partially also manufactured.

### DETAILED DESCRIPTION OF THE PREFERRED EMBODIMENT

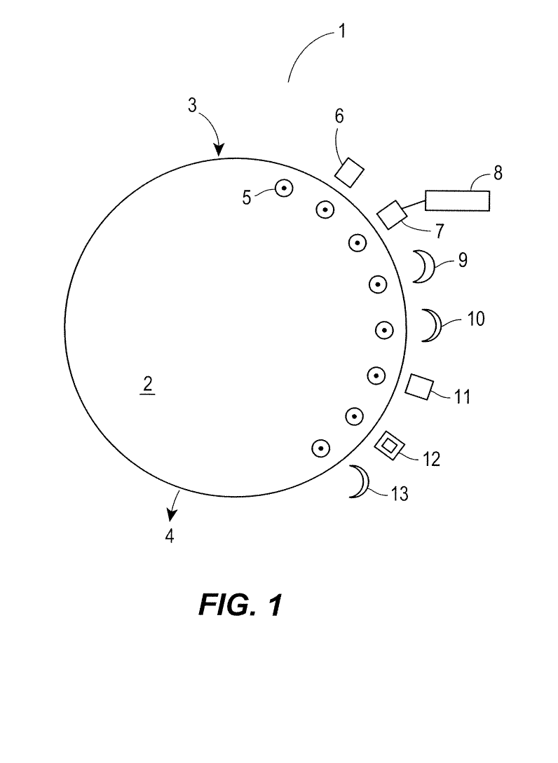

The labeling machine 1, which is shown partially in FIG. 1, comprises a clockwise turning carousel 2 with an inlet 3 and an outlet 4 for the bottles 5 to be labeled. The bottles, which can be provided with a support medium, such as, paper or film, with the help of which labels are manufactured, which are formed on the bottles, are introduced into a labeling section. Alternatively, according to the disclosure, labels that comprise a support medium can be manufactured at least in part before they are attached to the bottles.

Moreover, the description is made under the assumption that a support medium is applied on the bottles for the formation of labels. It is clear to a person skilled in the art that the direct formation on the surface of the bottles without support medium can occur analogously.

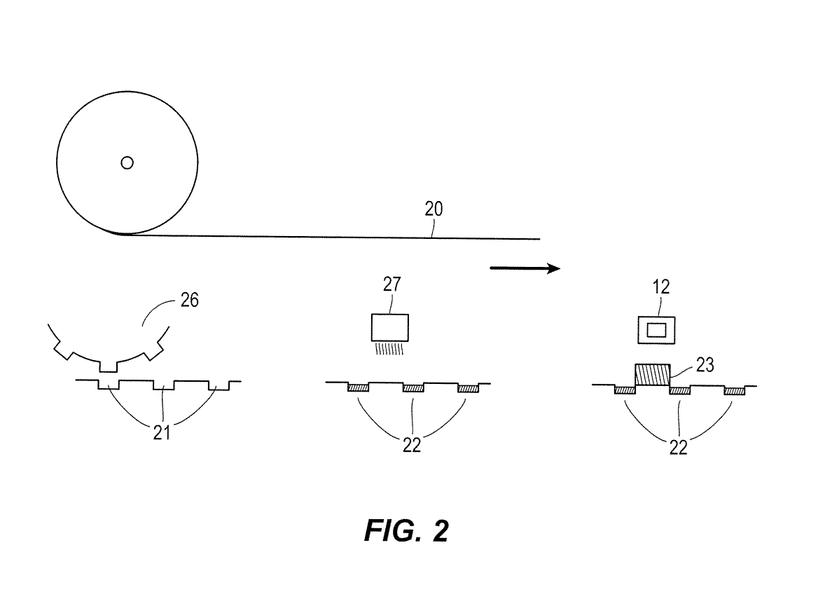

The labeling section comprises an embossing device 6, which is optionally followed by an embossing control device (not shown), which can control the embossing edge of the embossing introduced by the embossing device 6 in the support medium (see also FIG. 2), as well as a printing device 7, which, under the control of an ink and color control device 8, applies ink to the support medium in, and also outside of, the embossing. Different types of inks can be applied. In particular, an electrically conductive ink can be applied in the embossing. The printing device 7 comprises one or more fixed ink jet printing heads with piezo nozzles, allowing four- to eight-color printing with 600-800 dpi.

The labeling section comprises moreover a near infrared drying device 9, an ultraviolet hardening device 10, and an insulation device 11. The latter insulates particularly electrically conductive ink applied in the embossing. In addition, the support medium used can present an insulation layer on the top side, i.e., the side which is hit first by a stamp of the embossing device 6 during the embossing.

In the embodiment of the present disclosure, which has been described here, an antenna of a RFID transponder can be formed with the help of electrically conductive ink in the embossing, which is produced in the support medium with the help of the printing device 7.

A device 12 for applying a RFID microchip and for mechanically and electrically connecting the latter with a label or the antenna is used for the production of a RFID transponder in the label in the context of the application of the label on a bottle 5. The labeling section thus comprises in this embodiment a RFID production device for producing a RFID transponder, which comprises the printing device 7 and the device 12.

The microchip presents a self-resonant oscillation circuit, an additional load resistance, an additional capacitor, which can be charged inductively by a reading device and thus serves as the power supply of the RFID transponder, and a rewritable memory. In this example, a high-frequency transponder is thus produced, which modulates an electromagnetic field emitted by a reader, by load modulation with the help of a controllable resistance, and transmits data, which are stored in the storage device, to the reading device. The microchip can be connected mechanically with the label with the help of an adhesive back side. An additional UV hardening device 13 serves to fix the adhesive connection.

In an alternative embodiment, the printing of the label occurs directly, i.e., without the use of a support medium, on the bottle, which can be made, for example, of a PET material. If the printing is carried out with several printing heads connected one after the other, then, in each case, a drying and/or hardening device for fixing the ink can be arranged between the individual printing heads.

Furthermore, according to an alternative embodiment, not only the antenna of a RFID transponder can be printed as a component of the element which may be either a label that comprises a support medium or a label that is printed directly on a container, such as, a bottle rather at least a part of the RFID microchip is also manufactured with the help of the printing device 7. In this case, different materials are used for printing with the help of the printing device, including an appropriate polymer, to print conductors, but also electronic components. In the process, it is preferred for at least part of the manufacture of the label to occur under cleanroom conditions.

FIG. 2 illustrates several steps of an example for the procedure according to the disclosure for manufacturing a label with a RFID transponder. A support medium 20, which is applied with a roller, is embossed with the help of an embossing device 26, on that embossings (recesses) 21 form in the support medium. The support medium can be paper, an SK label, a coated PET film, etc. The support medium can be processed before the application on the surface of the container, or after it has already been applied to the container, for example, by gluing

The embossed support medium 20 is printed with the help of at least one printing head 27. The printing head prints electronically conductive ink 22 into the embossings 21, which results in the formation of an antenna of a RFID transponder in the support medium 20. Then, the drying and/or hardening of the ink can occur. The ink can present iron oxide, aluminum particles, silver particles, high-grade steel fibers, etc.

Before the printing, including printing with nonconductive inks, such as IR/UV ink, ink based on water or oil, or similar inks, in and outside of the recesses 21, the support medium can be subjected to an electrostatic preliminary treatment by ionization of the air layer located on the surface, so that, among other effects, the ink particles adhere better to the support medium.

To finish the RFID transponder, a RFID microchip 23 is applied and positioned from a corresponding device 12, and then glued with the support medium and connected electrically to the antenna. The latter may have been electrically insulated beforehand, in which case the insulation must be eliminated locally for the electrical connection with the microchip. The adhesive connection can then be UV hardened.

The above-mentioned steps can alternatively occur on the support medium which has already been attached to a bottle or to another container, or prior to the attachment of the finished label on a container. Each label in itself, which can be individualized by perforation or stamping from the band of the support medium, can contain, if desired, more than one RFID transponder.

1. Device for manufacturing a label for a container, particularly for a bottle, comprising:
a RFID production device which forms at least a part of a Radio Frequency Identification (RFID) transponder during the manufacture of the label.

2. Device according to claim 1, wherein the RFID production device comprises a printing device (7) for printing a part of a RFID transponder.

3. Device according to claim 2, in which the printing device (7) prints an electrically conductive ink.

4. Device according to claim 1, wherein the RFID production device forms an antenna as apart of the RFID transponder.

5. Device according to claim 1, wherein the RFID production device forms at least a part of the RFID transponder on one of a support medium (20) or immediately on a surface of the container.

6. Device according to claim 1, wherein the RFID production device forms at least apart of a RFID microchip (23) as a part of the RFID transponder.

7. Device according to additionally claim 1, and one of an embossing device (6), an ink and color control device (8), a drying device (9), a hardening device (10), an insulation device (11), a device for arranging a RFID microchip (12), a printing device for printing color ink, and combinations thereof.

8. Labeling machine comprising a device for manufacturing a label for a container according to claim 1, and a carousel for conveying containers.

9. Procedure for manufacturing a label for a container, comprising forming at least a part of a RFID transponder during the manufacture of the label.

10. Procedure according to claim 9, and forming the at least one part of the RFID transponder by printing.

11. Procedure according to claim 10, wherein the printing comprises the printing of an electrically conductive ink (22).

12. Procedure according to claim 9, where and forming an antenna as a part of the RFID transponder.

13. Procedure according to claim 9, where, and forming the at least one part of the RFID transponder on a support medium (20).

14. Procedure according to claim 13, and applying the support medium (20) to a surface of the container.

15. Procedure according to claim 9, and forming the at least one part of a RFID transponder directly on a surface of the container.

16. Procedure according to claim 9, and forming at least a part of a RFID microchip (23) as a part of the RFID transponder.

17. Procedure according to claim 10, and
embossing one of a support medium 20 or a surface of the container, to form an embossed area, and
the printing of at least a part of the RFID transponder occurs in the embossed area.

18. Procedure according to claim 17, and:
one of drying, hardening, and a combination thereof, of the electrically conductive ink.)

19. Procedure according to claim 17, comprising
forming one of an insulation layer or at least a part of the RFID transponder.

20. Procedure according to claim 12, comprising:
arranging a RFID microchip (23) so that the RFID microchip is in electrical contact with the antenna.

21. Label for a container, bottle, the label including at least a part of an RFID transponder.

22. Procedure according to claim 18, wherein the drying comprises near infrared drying.

23. Procedure according to claim 18, wherein the hardening comprises ultraviolet hardening.

24. Label according to claim 21, wherein said at least one part of the RFID transponder is printed in an electronically conductive ink.
